(19) United States
(12) Patent Application Publication
(10) Pub. No.: US 2018/0285504 A1
(43) Pub. Date: Oct. 4, 2018

(54) Behavioral Simulation Method and System for Temperature-Sensing Circuit Design with a Digital Output

(71) Applicant: National Kaohsiung First University of Science and Technology, Kaohsiung City (TW)

(72) Inventors: Chun-Chi Chen, Kaohsiung City (TW); Chao-Lieh Chen, Kaohsiung City (TW); You-Ting Lin, Kaohsiung City (TW)

(21) Appl. No.: 15/475,225

(22) Filed: Mar. 31, 2017

(51) Int. Cl. G06F 17/50; G06F 17/13

(52) U.S. Cl. CPC G06F 17/5036; G06F 17/13

(57) ABSTRACT

A behavioral simulation system includes a behavioral simulation software provided in a first simulation platform, a temperature-sensing circuit mathematic module suitable for the behavioral simulation software and an advanced simulation software or real measurement data provided in a second simulation platform. The temperature-sensing circuit mathematic module includes a plurality of component mathematic modules. At least one of the component mathematic modules is selectively designated for preliminary simulation. The advanced simulation software or the real measurement data is applied to calculate the at least one of designated component mathematic module to obtain a designated component temperature module which is combined with the temperature-sensing circuit mathematic module for calculating behavioral simulation in the behavioral simulation software for rapidly supplying a preliminary simulation data or digital output.

### BACKGROUND OF THE INVENTION

### 1. Field of the Invention

The present invention relates to a behavioral simulation method and system for temperature-sensing circuit designs with a digital output. Particularly, the present invention relates to the behavioral simulation method and system for early design stages of temperature-sensing circuits with the digital output. More particularly, the present invention relates to the behavioral simulation method and system for CMOS temperature-sensing circuit designs with the digital output.

### 2. Description of the Related Art

U.S. Patent Application Publication No. 2016/0048622, entitled “Simulation system estimating self-heating characteristic of circuit and design method thereof,” discloses a simulation method and system for circuit designs in self-heating. The simulation method and system of designing semiconductor circuits using a circuit simulation tool is executed by a computer.

The method includes calculating power consumptions of elements of the semiconductor circuit by use of the circuit simulation tool. A thermal netlist is created about the semiconductor circuit, based on the power consumptions and geometry information of each of the elements. A simulation of the semiconductor circuit is performed with the thermal netlist using the circuit simulation tool to detect a temperature of each of the elements. The thermal netlist includes thermal capacitance information of each of the elements.

Another U.S. Patent Application Publication No. 2011/0301923, entitled “Equivalent circuit simulation system and method for HSPICE,” discloses a simulation system and method for generating equivalent circuits compatible with HSPICE. The simulation system includes a data obtaining module, a data storage module, a parameter checking module, a function generating module and an equivalent circuit generating module.

A simulation system and method reads data corresponding to a N-port network system format in a storage device, and obtains S-parameter matrixes from the N-port network system. S-parameters in the S-parameter matrix that satisfy passivity are checked, and an interpolation algorithm to supplement S-parameters with passivity when some S-parameters not satisfy passivity is performed. Numbers of pole-residue, times for recursion and a tolerant system error of a rational function are generated for determining S-parameters. A rational function matrix composed of S-parameters is generated by performing a vector fitting algorithm, and an equivalent circuit is generated compatible with HSPICE format based on the generated rational function matrix.

However, there is a need of improving a conventional simulation system and method for designing semiconductor circuits for simplifying entire simulation operation and reducing total simulation time. The above-mentioned patent publications are incorporated herein by reference for purposes including, but not limited to, indicating the background of the present invention and illustrating the situation of the art.

As is described in greater detail below, the present invention provides a behavioral simulation method and system for temperature-sensing circuit designs with a digital output. A temperature-sensing circuit mathematic module suitable for executing with behavioral simulation software is selectively built. The temperature-sensing circuit mathematic module includes a plurality of component mathematic modules. An advanced simulation software or real measurement data is selected to simulate at least one designated component mathematic module of the temperature-sensing circuit mathematic module to obtain a designated component temperature module. The designated component temperature module is combined with the temperature-sensing circuit mathematic module for calculating behavioral simulation in the behavioral simulation software for rapidly supplying a preliminary simulation data or digital output thereof in such a way as to mitigate and overcome the above problem.

### SUMMARY OF THE INVENTION

The primary objective of this invention is to provide a behavioral simulation method and system for temperature-sensing circuit designs with a digital output. A temperature-sensing circuit mathematic module suitable for executing with behavioral simulation software is selectively built. The temperature-sensing circuit mathematic module includes a plurality of component mathematic modules. An advanced simulation software or real measurement data is selected to simulate at least one designated component mathematic module of the temperature-sensing circuit mathematic module to obtain a designated component temperature module. The designated component temperature module is combined with the temperature-sensing circuit mathematic module for calculating behavioral simulation in the behavioral simulation software for rapidly supplying a preliminary simulation data or digital output thereof. Advantageously, the behavioral simulation method and system of the present invention is successful in simplifying entire simulation operation and reducing total simulation time.

The behavioral simulation method in accordance with an aspect of the present invention includes:

selectively building a temperature-sensing circuit mathematic module suitable for executing with a behavioral simulation software, with the temperature-sensing circuit mathematic module including a plurality of component mathematic modules;

selectively designating at least one or a plurality of the component mathematic modules for preliminary simulation;

selecting an advanced simulation software or real measurement data to simulate the at least one or plurality of designated component mathematic module to obtain a designated component temperature module; and

combining the designated component temperature module with the temperature-sensing circuit mathematic module for calculating behavioral simulation in the behavioral simulation software for rapidly supplying a preliminary simulation data or digital output thereof.

In a separate aspect of the present invention, the temperature-sensing circuit mathematic module is formed as a time-domain smart temperature-sensing circuit mathematic module or a voltage-domain smart temperature-sensing circuit mathematic module.

In a further separate aspect of the present invention, the designated component mathematic module is formed as a time-temperature conversion circuit module or a voltage-temperature conversion circuit module.

In yet a further separate aspect of the present invention, the behavioral simulation software is selected from a Simulink simulation software.

In yet a further separate aspect of the present invention, the advanced simulation software is selected from a HSPICE simulation software.

In yet a further separate aspect of the present invention, an advanced simulation data is obtained from calculating the temperature-sensing circuit mathematic module in the advanced simulation software or with the real measurement data for advanced simulation.

The behavioral simulation system in accordance with an aspect of the present invention includes:

a behavioral simulation software provided in a first simulation platform;

a temperature-sensing circuit mathematic module suitable for the behavioral simulation software, with the temperature-sensing circuit mathematic module including a plurality of component mathematic modules; and

an advanced simulation software or real measurement data provided in a second simulation platform as an auxiliary simulation tool;

wherein at least one of the component mathematic modules is selectively designated for preliminary simulation; and

wherein the advanced simulation software or the real measurement data is applied to calculate the at least one of designated component mathematic module to obtain a designated component temperature module which is combined with the temperature-sensing circuit mathematic module for calculating behavioral simulation in the behavioral simulation software for rapidly supplying a preliminary simulation data or digital output thereof.

In a separate aspect of the present invention, the temperature-sensing circuit mathematic module is formed as a time-domain smart temperature-sensing circuit mathematic module or a voltage-domain smart temperature-sensing circuit mathematic module.

In a further separate aspect of the present invention, the designated component mathematic module is formed as a time-temperature conversion circuit module or a voltage-temperature conversion circuit module.

In yet a further separate aspect of the present invention, the behavioral simulation software is selected from a Simulink simulation software.

In yet a further separate aspect of the present invention, the advanced simulation software is selected from a HSPICE simulation software.

In yet a further separate aspect of the present invention, an advanced simulation data is obtained from calculating the temperature-sensing circuit mathematic module in the advanced simulation software or with the real measurement data for advanced simulation.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a behavioral simulation system in accordance with a preferred embodiment of the present invention.

FIG. 1A is a structurally schematic view of a first temperature-sensing circuit and a mathematical module simulated in the behavioral simulation system in accordance with a preferred embodiment of the present invention.

FIG. 1B is a block diagram of a second temperature-sensing circuit simulated in the behavioral simulation system in accordance with another preferred embodiment of the present invention.

FIG. 2 is a series of signal waveforms generated in the behavioral simulation system in accordance with the preferred embodiment of the present invention.

FIG. 3 is a structural block diagram of a mathematical module of the first temperature-sensing circuit built by the behavioral simulation system in accordance with the preferred embodiment of the present invention.

FIG. 4 is a structural block diagram of a component mathematic module of a temperature-time conversion circuit of the first temperature-sensing circuit in accordance with the preferred embodiment of the present invention.

FIG. 4A is a structural block diagram of the component mathematic module of the temperature-time conversion circuit applied to simulate with a series of basic elements in accordance with the preferred embodiment of the present invention.

FIG. 5 is a structural view of a component mathematic module of a time amplifier circuit of the first temperature-sensing circuit in accordance with the preferred embodiment of the present invention.

FIG. 6 is a structural view of a component mathematic module of a time-digital conversion circuit of the first temperature-sensing circuit in accordance with the preferred embodiment of the present invention.

FIG. 7 is a structural block diagram of digital simulation outputs of the first temperature-sensing circuit from the behavioral simulation system in accordance with the preferred embodiment of the present invention.

FIG. 8A is a chart of digital number N(T) in relation to temperature generated in the behavioral simulation system in accordance with the first preferred embodiment of the present invention.

FIG. 8B is a chart of temperature difference (i.e. digital number difference) of errors in relation to temperature generated in the behavioral simulation system in accordance with the first preferred embodiment of the present invention.

### DETAILED DESCRIPTION OF THE INVENTION

It is noted that a behavioral simulation method and simulator structure for temperature-sensing circuit designs with a digital output in accordance with the preferred embodiment of the present invention can be applicable to various automatic or semi-automatic behavioral simulation methods for systematic temperature-sensing circuit designs, which are not limitative of the present invention. Additionally, a behavioral simulation system for temperature-sensing circuit designs with a digital output of the preferred embodiment of the present invention is suitable for various automatic or semi-automatic behavioral simulation systems for temperature-sensing circuit designs, including temperature monitoring systems or temperature management systems, for example, which are not limitative of the present invention.

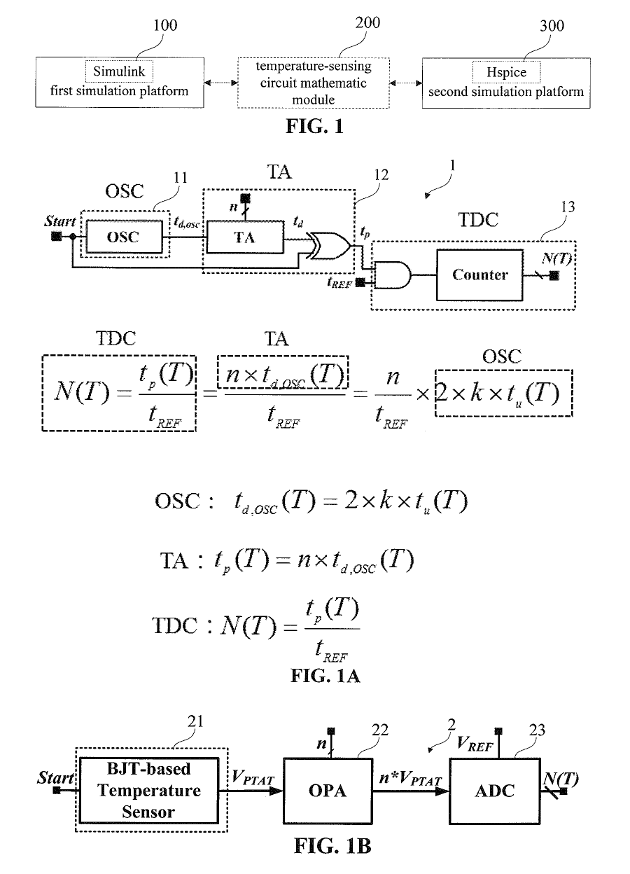

FIG. 1 shows a block diagram of a behavioral simulation system in accordance with a preferred embodiment of the present invention. Referring to FIG. 1, the behavioral simulation system of the preferred embodiment of the present invention includes a behavioral simulation software (e.g. Simulink simulation software, other preliminary simulation software) 100, a temperature-sensing circuit mathematic module 200 and an advanced simulation software (e.g. HSPICE simulation software, other advanced simulation software) 300 or real measurement data. The temperature-sensing circuit mathematic module 200 has a framework suitable for executing the behavioral simulation software 100 and the advanced simulation software 300. Furthermore, the temperature-sensing circuit mathematic module 200 includes at least one or a plurality of component mathematic modules.

With continued reference to FIG. 1, the behavioral simulation software 100 or other preliminary simulation software is provided in a first simulation platform (e.g. Matlab platform). The advanced simulation software 300 or the real measurement data (e.g. inverse deduction of real measurement data, process data or other equivalent data) is further provided in a second simulation platform.

With continued reference to FIG. 1, the behavioral simulation software 100 is suitable for preliminary simulation which requires less simulation time due to less systematic resource required in computer. In comparison with the behavioral simulation software 100, the advanced simulation software 300 is suitable for advanced simulation which requires more variances in process parameters (e.g. processes, voltages, temperatures or other parameters) which results in requiring longer simulation time and more systematic resource required in computer.

FIG. 1A shows a structurally schematic view of a design of first temperature-sensing circuit and a mathematical module thereof simulated in the behavioral simulation system in accordance with a preferred embodiment of the present invention. Referring now to FIGS. 1 and 1A, the first temperature-sensing circuit mathematic module is a mathematic module of time-domain smart temperature-sensing circuit 1. The time-domain smart temperature-sensing circuit 1 includes a temperature-time conversion circuit (e.g. oscillation circuit, OSC) 11, a time amplifying circuit (e.g. time amplifier, TA) 12 and a time-digital conversion (TDC) circuit (e.g. counter) 13. Each of the temperature-time conversion circuit 11, the time amplifying circuit 12 and the time-digital conversion circuit 13 includes at least one or a plurality of components, as best shown in the upper portion in FIG. 1A.

FIG. 1B shows a block diagram of a design of second temperature-sensing circuit simulated in the behavioral simulation system in accordance with another preferred embodiment of the present invention, corresponding to the first temperature-sensing circuit in FIG. 1A. Referring now to FIG. 1B, the second temperature-sensing circuit mathematic module is a mathematic module of voltage-domain smart temperature-sensing circuit 2. The voltage-domain smart temperature-sensing circuit 2 includes a temperature-voltage conversion circuit (e.g. bipolar transistor) 21, a voltage amplifying circuit (e.g. operational amplifier, OPA) 22 and a voltage-digital conversion circuit (e.g. analog-digital converter, ADC) 23.

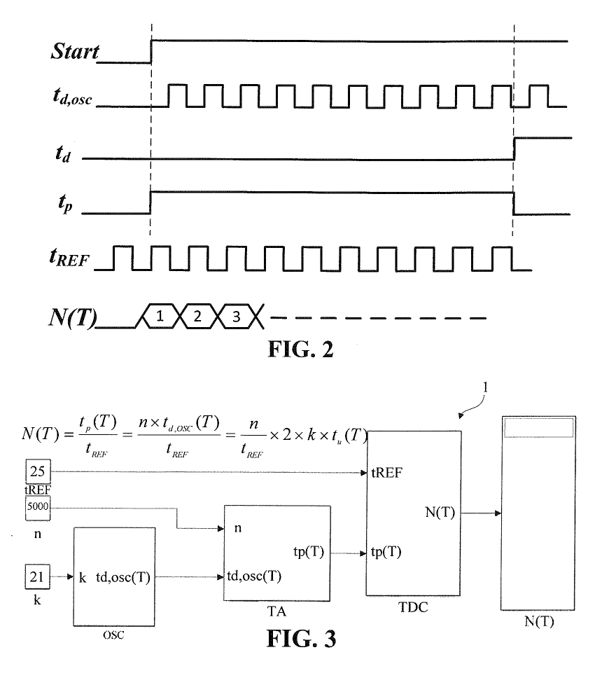

FIG. 2 shows a series of signal waveforms generated in the behavioral simulation system in accordance with the preferred embodiment of the present invention. Referring now to FIGS. 1A and 2, the temperature-time conversion circuit (oscillator) 11 converts a signal “Start” to an oscillation signal (periodic, oscillating electronic signal) “t_{d,osc}” with an oscillating period (i.e. oscillating periodic width) to supply to the time amplifying circuit 12. A signal width with the oscillating periods of oscillation signal “t_{d,osc}” can be increased according to temperature increases. As received the signal “t_{d,osc}”, the time amplifying circuit 12 is operated with an input amplifier parameter “n” (i.e. time amplification factor) and subsequently the time amplifying circuit 12 produces an output parameter “t_{d}” (i.e. delayed pulse signal) with a quantity of “n” oscillating periods of oscillation signal “t_{d,osc}” of delay such that a waveform of output parameter “t_{d}” ascends after “n” oscillating periods of oscillation signal “t_{d,osc}” of delay. For example, if a quantity of input amplifier parameter “n” is 10, the waveform of output signal “t_{d}” ascends after completely oscillating ten oscillating periods of oscillation signal “t_{d,osc}”. A pulse width “tₚ” of temperature-to-time conversion is located between starting the signal “Start” and ascending the output parameter “t_{d}”. Accordingly, the pulse width “tₚ” of temperature-to-time conversion increases as temperature increases. After oscillating ten oscillating periods of oscillation signal “t_{d,osc}” delay completely, the pulse width “tₚ” of temperature-to-time conversion equals ten pulse widths of oscillating periods of oscillation signal “t_{d,osc}”.

With continued reference to FIGS. 1A and 2, the time-digital conversion circuit 13 is operated to measure the pulse width “tₚ” of temperature-to-time conversion with the number of reference pulse periods “t_{REF}”. By way of example, a counter is applied to count the number of reference pulse periods “t_{REF}” which further outputs a digital number N(T) as a numeral value of measured temperature.

FIG. 3 shows a structural block diagram of a mathematical module of the first temperature-sensing circuit built by the behavioral simulation system in accordance with the preferred embodiment of the present invention, corresponding to the temperature-sensing circuit mathematical module of first temperature-sensing circuit in FIG. 1A. Referring again to FIGS. 1, 1A and 3, the behavioral simulation method includes the step of: selectively building a temperature-sensing circuit mathematic module suitable for executing with the behavioral simulation software 100. The behavioral simulation software is selected from a Simulink simulation software or other equivalent software. The temperature-sensing circuit mathematic module is formed as a mathematic module of time-domain smart temperature-sensing circuit 1, further including a plurality of the component mathematic modules selected from a temperature-time conversion circuit mathematic module, a time amplifying circuit mathematic module, a time-digital conversion circuit mathematic module or other mathematic sub-module.

With continued reference to FIGS. 1, 1A, 1B and 3, the behavioral simulation method includes the step of: selectively designating at least one or a plurality of the component mathematic modules as a primary component mathematic module for preliminary simulation. By way of example, the mathematic module of temperature-time conversion circuit 11 or temperature-voltage conversion circuit 21 is selectively designated for preliminary simulation.

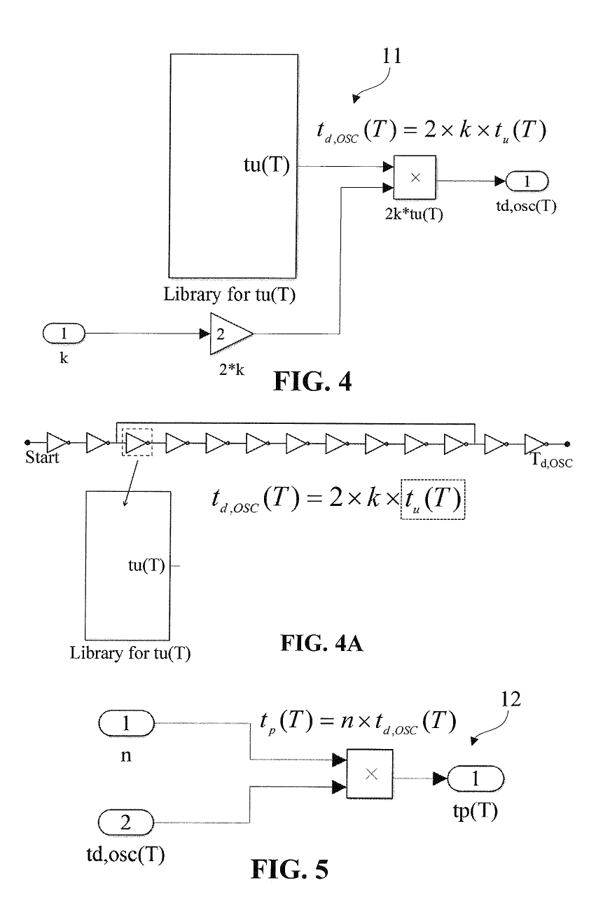

FIG. 4 shows a structural block diagram of a component mathematic module of a designated temperature-time conversion circuit of the first temperature-sensing circuit in accordance with the preferred embodiment of the present invention. FIG. 4A shows a structural block diagram of the component mathematic module of the temperature-time conversion circuit applied to simulate with a series of basic elements in accordance with the preferred embodiment of the present invention. With continued reference to FIGS. 1, 1A, 4 and 4A, the behavioral simulation method includes the step of: selecting an advanced simulation software (e.g. HSPICE simulation software) or real measurement data to simulate the at least one or plurality of designated component mathematic module of the temperature-time conversion circuit 11 to obtain a designated component temperature module.

In a preferred embodiment, for example, the designated component temperature module can be expressed by

$${t}_{u} ( T ) = \frac{2 {LC}_{L} {T}_{0}^{km}}{{μ}_{0} {WC}_{ox} {V}_{DD}} \times \frac{ln ( 3 - 4 {V}_{th} \text{/} {V}_{DD} )}{1 - {V}_{th} \text{/} {V}_{DD}} \times \frac{1}{{T}^{km}} = γ \times {T}^{- k m}$$

where μ₀ is a reference carrier mobility, T is an operation temperature, T₀ is a reference temperature, Vₜₕ is a threshold voltage, W/L is an effective aspect ratio of transistors and C_{L} is a loading capacitance of NOT gates.

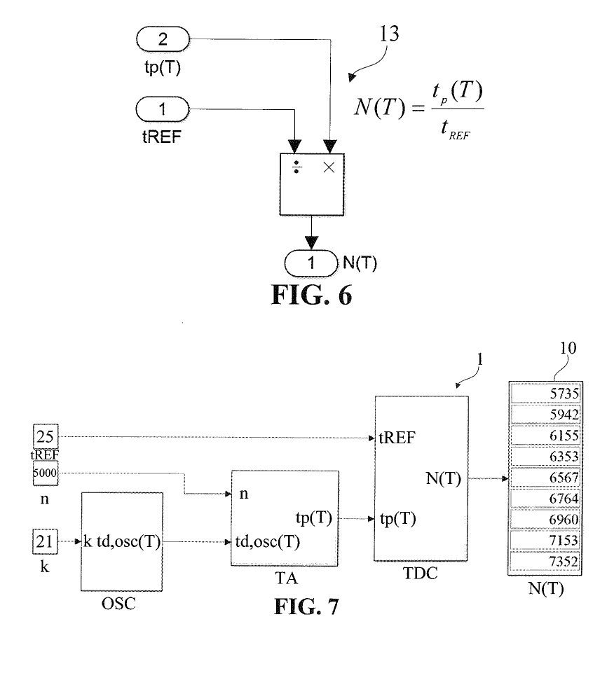

FIG. 5 shows a structural view of a component mathematic module of a time amplifier circuit of the first temperature-sensing circuit in accordance with the preferred embodiment of the present invention. FIG. 6 shows a structural view of a component mathematic module of a time-digital conversion circuit of the first temperature-sensing circuit in accordance with the preferred embodiment of the present invention. Referring now to FIGS. 5 and 6, by way of example, the component mathematic modules of the time amplifying circuit 12 and the time-digital conversion circuit 13 are designated as secondary component mathematic modules which are suitable for executing in the behavioral simulation software 100 for complete simulation.

FIG. 7 shows a structural block diagram of digital simulation outputs of the first temperature-sensing circuit from the behavioral simulation system in accordance with the preferred embodiment of the present invention. Turning now to FIGS. 1, 1A, 4, 4A and 7, the behavioral simulation method includes the step of: combining the designated component temperature module with the temperature-sensing circuit mathematic module for calculating behavioral simulation in the behavioral simulation software 100 for rapidly supplying a preliminary simulation data 10 (e.g. Simulink simulation data or other simulation software data) or digital output thereof.

Referring back to FIGS. 1, 1A, 4 and 4A, the behavioral simulation method further includes the step of: calculating the mathematic module of the time-domain smart temperature-sensing circuit 1 in the advanced simulation software 300 to obtain an advanced simulation data (e.g. HSPICE simulation data). Alternatively, the advanced simulation data is obtained from calculating the mathematic module of the time-domain smart temperature-sensing circuit 1 with the real measurement data.

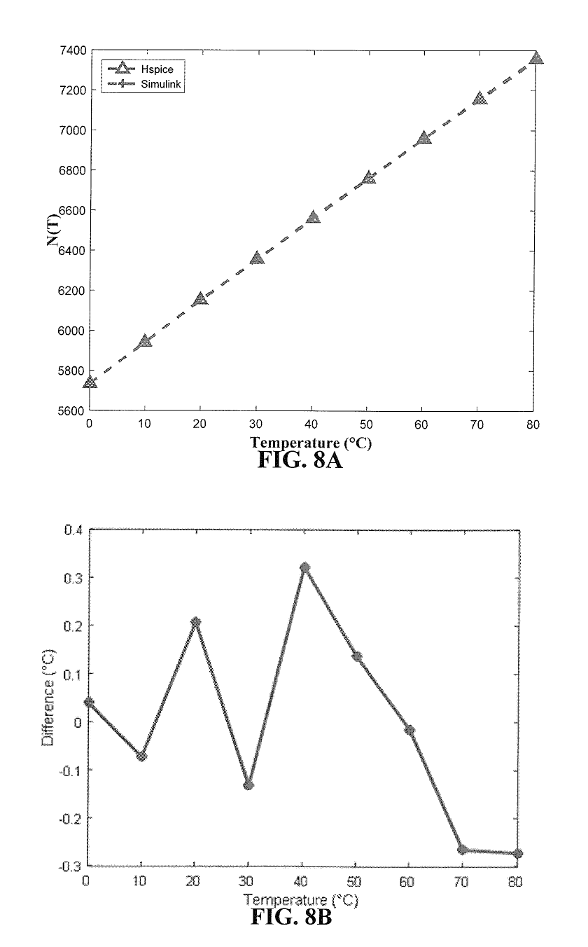

FIG. 8A is a chart of digital number N(T) in relation to temperature generated in the behavioral simulation system in accordance with the first preferred embodiment of the present invention. Referring now to FIGS. 7 and 8A, in comparing the preliminary simulation data 10 with the advanced simulation data, the Simulink simulation data (as indicated at cross symbols in FIG. 8A) are nearly identical with the HSPICE simulation data (as indicated at triangle symbols in FIG. 8A) between 0-80 degrees Centigrade.

FIG. 8B shows a chart of temperature difference (i.e. digital number difference) of errors in relation to temperature generated in the behavioral simulation system in accordance with the first preferred embodiment of the present invention. Referring now to FIGS. 8A and 8B, in comparing the preliminary simulation data 10 with the advanced simulation data between 0-80 degrees Centigrade, temperature difference (i.e. digital number difference) of errors between the Simulink simulation data and the HSPICE simulation data are ranging between 0.4 and −0.3 degree Centigrade.

As described above, the behavioral simulation system of the present invention is successful in generating simulation data with an advantage of full advanced simulation software. Referring back to FIGS. 1 and 7, the behavioral simulation method further includes the step of: outputting the preliminary simulation data 10 to a sub-platform (e.g. Matlab platform) for data post-processing or drawing.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A behavioral simulation method comprising:
selectively building a temperature-sensing circuit mathematic module suitable for executing with a behavioral simulation software, with the temperature-sensing circuit mathematic module including a plurality of component mathematic modules;
selectively designating at least one of the component mathematic modules for preliminary simulation;
selecting an advanced simulation software to simulate the at least one of designated component mathematic module to obtain a designated component temperature module; and
combining the designated component temperature module with the temperature-sensing circuit mathematic module for calculating behavioral simulation in the behavioral simulation software for rapidly supplying a preliminary simulation data or digital output thereof.

2. The method as defined in claim 1, wherein the temperature-sensing circuit mathematic module is formed as a time-domain smart temperature-sensing circuit mathematic module or a voltage-domain smart temperature-sensing circuit mathematic module.

3. The method as defined in claim 1, wherein the designated component mathematic module is formed as a time-temperature conversion circuit module or a voltage-temperature conversion circuit module.

4. The method as defined in claim 1, wherein the behavioral simulation software is selected from a Simulink simulation software.

5. The method as defined in claim 1, wherein the advanced simulation software is selected from a HSPICE simulation software.

6. The method as defined in claim 1, wherein an advanced simulation data is obtained from calculating the temperature-sensing circuit mathematic module in the advanced simulation software for advanced simulation.

7. A behavioral simulation method comprising:
selectively building a temperature-sensing circuit mathematic module suitable for executing with a behavioral simulation software, with the temperature-sensing circuit mathematic module including a plurality of component mathematic modules;
selectively designating at least one of the component mathematic modules for preliminary simulation;
selecting real measurement data to simulate the at least one of designated component mathematic module to obtain a designated component temperature module; and
combining the designated component temperature module with the temperature-sensing circuit mathematic module for calculating behavioral simulation in the behavioral simulation software for rapidly supplying a preliminary simulation data or digital output thereof.

8. The method as defined in claim 7, wherein the temperature-sensing circuit mathematic module is formed as a time-domain smart temperature-sensing circuit mathematic module or a voltage-domain smart temperature-sensing circuit mathematic module.

9. The method as defined in claim 7, wherein the designated component mathematic module is formed as a time-temperature conversion circuit module or a voltage-temperature conversion circuit module.

10. The method as defined in claim 7, wherein the behavioral simulation software is selected from a Simulink simulation software.

11. The method as defined in claim 7, wherein the advanced simulation software is selected from a HSPICE simulation software.

12. The method as defined in claim 7, wherein an advanced simulation data is obtained from calculating the temperature-sensing circuit mathematic module with the real measurement data for advanced simulation.

13. A behavioral simulation system comprising:
a behavioral simulation software provided in a first simulation platform;
a temperature-sensing circuit mathematic module suitable for the behavioral simulation software, with the temperature-sensing circuit mathematic module including a plurality of component mathematic modules; and
an auxiliary simulation tool provided in a second simulation platform;
wherein at least one of the component mathematic modules is selectively designated for preliminary simulation; and
wherein the an auxiliary simulation tool is applied to calculate the at least one of designated component mathematic module to obtain a designated component temperature module which is combined with the temperature-sensing circuit mathematic module for calculating behavioral simulation in the behavioral simulation software for rapidly supplying a preliminary simulation data or digital output thereof.

14. The system as defined in claim 13, wherein the auxiliary simulation tool is selected from an advanced simulation software, real measurement data or combination thereof.

15. The system as defined in claim 14, wherein an advanced simulation data is obtained from calculating the temperature-sensing circuit mathematic module in the advanced simulation software for advanced simulation.

16. The system as defined in claim 14, wherein an advanced simulation data is obtained from calculating the temperature-sensing circuit mathematic module with the real measurement data for advanced simulation.

17. The system as defined in claim 13, wherein the temperature-sensing circuit mathematic module is formed as a time-domain smart temperature-sensing circuit mathematic module or a voltage-domain smart temperature-sensing circuit mathematic module.

18. The system as defined in claim 13, wherein the designated component mathematic module is formed as a time-temperature conversion circuit module or a voltage-temperature conversion circuit module.

19. The system as defined in claim 13, wherein the behavioral simulation software is selected from a Simulink simulation software.

20. The system as defined in claim 13, wherein the advanced simulation software is selected from a HSPICE simulation software.
